(19) United States
(12) Patent Application Publication
(10) Pub. No.: US 2012/0026390 A1
(43) Pub. Date: Feb. 2, 2012

(54) Interpolation Frame Generating Apparatus and Interpolation Frame Generating Method

(76) Inventor: Noriyuki Matsuhira, Tama-shi (JP)

(21) Appl. No.: 13/099,788

(22) Filed: May 3, 2011

(30) Foreign Application Priority Data
Jul. 30, 2010 (JP) 2010-172748

(51) Int. Cl. H04N 7/01

(52) U.S. Cl. 348/441; 348/E07.003

(57) ABSTRACT

According to one embodiment, there is provided an interpolation frame generating apparatus, including: an input module configured to receive plural frames; a reading module configured to read, among the received plural frames, two or more frames each time; a detecting module configured to detect an inter-frame motion vector between the read-in frames; and a generating module configured to generate an interpolation frame based on the detected motion vector and the read-in frames, wherein the reading module reads the two or more frames to have orientation corresponding to a direction of the detected motion vector.

### CROSS-REFERENCE TO RELATED APPLICATION(S)

This application is based upon and claims the benefit of priority from Japanese Patent Application No. 2010-172748, filed on Jul. 30, 2010, the entire contents of which are incorporated herein by reference.

### FIELD

Embodiments described herein relate generally to an interpolation frame generating apparatus and an interpolation frame generating method.

### BACKGROUND

In displaying a moving image, display apparatus display frames at a rate of 60 frames/s, for example. That is, display apparatus continue to display each frame for 1/60 second. When a moving image is displayed on a hold-type display apparatus such as an LCD, the user recognizes a one-frame-preceding frame as an afterimage and may feel an object movement in video unnatural. Such an afterimage is more conspicuous when the one-frame display period is longer.

For example, to suppress such afterimage phenomenon, an interpolation frame is inserted between two consecutive frames and thereby shorten the one-frame display period. In this method, first, matching is performed between image blocks constituting two or more consecutive frames and inter-frame motion vectors are detected for respective image blocks. A motion vector is detected by, for example, detecting to what sets of coordinates in the next frame pixels having certain sets of coordinates in a frame have been moved. A new, interpolation frame to be inserted between input frames is generated based on motion vectors of respective image blocks and the input frames.

Incidentally, in detection of a motion vector, to reduce its processing amount, only pixels whose sets of coordinates are within a certain range with respect to certain coordinates in a preceding frame are employed as processing subjects for motion vector detection. It is preferable that proper interpolation frames be generated even in such a case.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIGS. 1A and 1B illustrate a TV receiver according to an embodiment and matching processing performed therein, respectively.

FIG. 2 illustrates a functional configuration of the TV receiver according to the embodiment.

FIGS. 3A and 3B illustrate analysis performed by the TV receiver according to the embodiment.

FIGS. 4A-4E illustrate example processings that a frame is read or an interpolation frame is written in the TV receiver according to the embodiment.

FIGS. 5A and 5B illustrate a case where a vertical movement between the frames is small.

FIGS. 6A and 6B illustrate a case where a vertical movement between the frames is large.

FIGS. 7A and 7B illustrate a case where each frame is read area by area.

FIG. 8 is a flowchart illustrating video display process executed by the TV receiver according to the embodiment.

FIG. 9 is a flowchart illustrating interpolation frame generation process executed by the TV receiver according to the embodiment.

### DETAILED DESCRIPTION

In general, according to one embodiment, there is provided an interpolation frame generating apparatus, including: an input module configured to receive plural frames; a reading module configured to read, among the received plural frames, two or more frames each time; a detecting module configured to detect an inter-frame motion vector between the read-in frames; and a generating module configured to generate an interpolation frame based on the detected motion vector and the read-in frames, wherein the reading module reads the two or more frames to have orientation corresponding to a direction of the detected motion vector.

An embodiment will be hereinafter described with reference to the drawings.

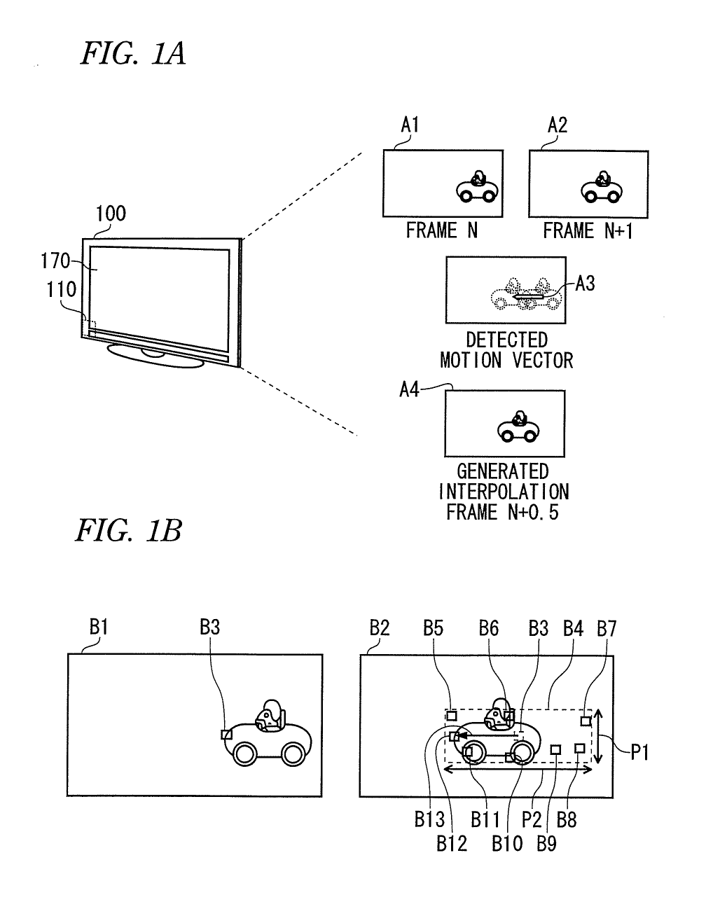

FIG. 1A illustrates a TV receiver 100 as an example of an interpolation frame generating apparatus according to the embodiment.

The TV receiver 100 is equipped with a receiving unit 110 and a display unit 170. The TV receiver 100 has a function of displaying, on the display unit 170, video of a TV broadcast or the like received by the receiving unit 110. The TV receiver 100 generates one or more interpolation frames to be displayed between plural frames of input video based on the plural frames. The TV receiver 100 can display, on the display unit 170, video in which interpolation frames are inserted between the frames.

For example, the TV receiver 100 generates an interpolation frame to be inserted between two input frames based on the two input frames. When an Nth frame A1 and an (N+1)th frame A2 are input, an image block motion vector A3 is detected between the frames A1 and A2 by performing matching on image blocks constituting the frames A1 and A2 by analyzing the frames A1 and A2. The TV receiver 100 generates an interpolation frame A4 based on the motion vector A3 and the frames A1 and A2. The TV receiver 100 displays video having a larger number of frames than the input video by inserting interpolation frames between the input frames.

FIG. 1B illustrates matching processing performed by the TV receiver 100. For example, the TV receiver 100 performs matching between image blocks constituting an Nth frame B1 and an (N+1)th frame B2 or these two frames B1 and B2 and other frames. The matching is a method for determining with what image block in the next frame an image block having a predetermined size (resolution) in a certain frame coincides.

In the matching, differences between the pixels in an image block in a certain frame and the pixels, located at the same positions, in each image block in the next frame are calculated. An image block producing a minimum sum of absolute differences (SAD) in the next frame is detected as an image block that is most similar to the image block in the certain frame. A difference between the positions of these two image blocks is detected as a motion vector.

Where an image block B3, for example, in the frame B1 is a matching subject image block, the TV receiver 100 employs, as matching subject blocks, image blocks B5-B12 that are located in an area B4 that is within a distance corresponding to a predetermined number of pixels of the position (coordinates) of the image block B3. In this example, the block B12 is detected as a block having a highest correlation with (most similar to) the block B3 and a difference B13 between the positions of the blocks B3 and B12 is detected as a motion vector.

In the TV receiver 100, the motion vector detection area B4 is, for example, an oblong area whose horizontal length is greater than its vertical length. This is because in general video horizontal movements tend to be larger than vertical movements. Setting a horizontally long motion vector detection area enables detection of large horizontal movements. However, a vertical movement in video that is longer than the vertical length of the area B4 may not be detected.

In view of the above, in the TV receiver 100 according to the embodiment, each frame is read so as to be oriented in a proper direction, whereby the accuracy of motion vector detection can be increased and proper interpolation frames can be generated.

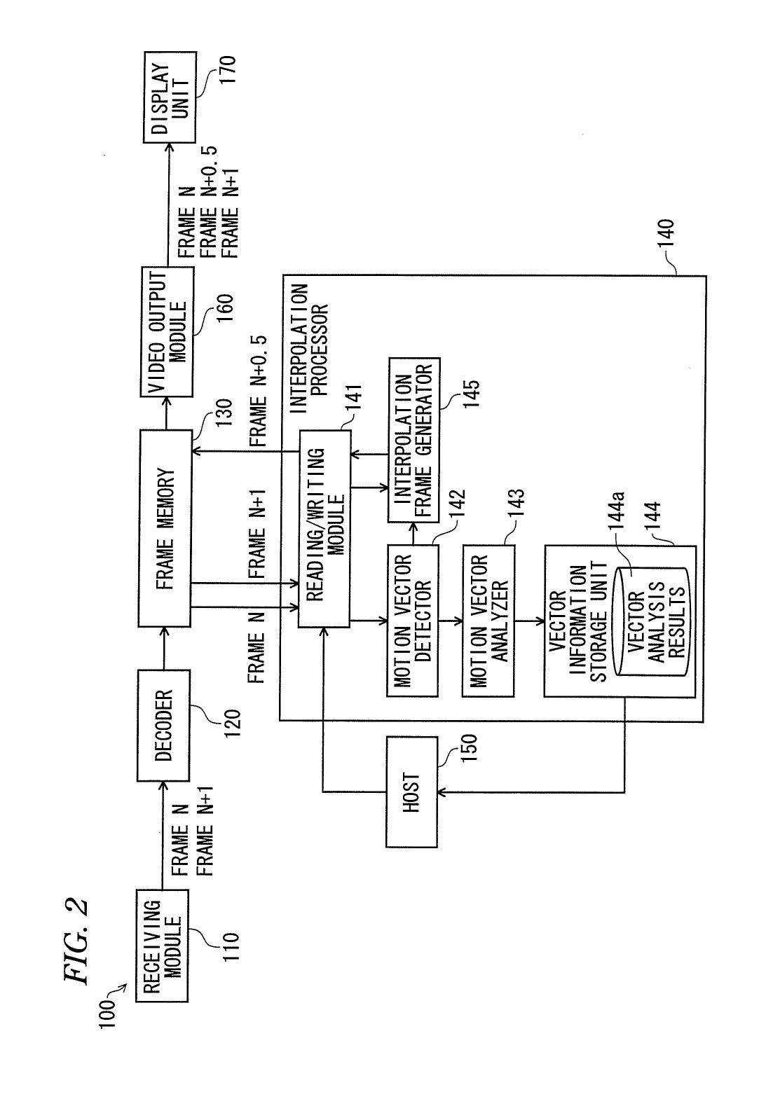

Next, an example functional configuration of the TV receiver 100 will be described with reference to FIG. 2. The TV receiver 100 is equipped with a receiving module 110, a decoder 120, a frame memory 130, an interpolation processor 140, a host 150, a video output module 160, a display unit 170, etc. The receiving module 110 has a function of receiving video of a TV broadcast or the like. The receiving module 110 may receive video of IP TV, for example. The receiving module 110 outputs received video data to the decoder 120.

The decoder 120 decodes the received video data and thereby generates plural frames. The decoder 120 outputs the generated frames to the frame memory 130.

The frame memory 130 buffers plural frames that are input from the decoder 120. The interpolation processor 140 inputs an interpolation frame to the frame memory 130. The frame memory 130 outputs, to the video output module 160, frames that are input from the decoder 120 and the interpolation frame that is input from the interpolation processor 140.

The interpolation processor 140 is provided with a reading/writing module 141, a motion vector detector 142, a motion vector analyzer 143, a vector information storage unit 144, an interpolation frame generator 145, etc. The interpolation processor 140 has a function of reading two of the frame being buffered by the frame memory 130 from the frame memory 130 according to an instruction from the host 150, generating an interpolation frame to be inserted between the two frames, and writing the generated interpolation frame to the frame memory 130.

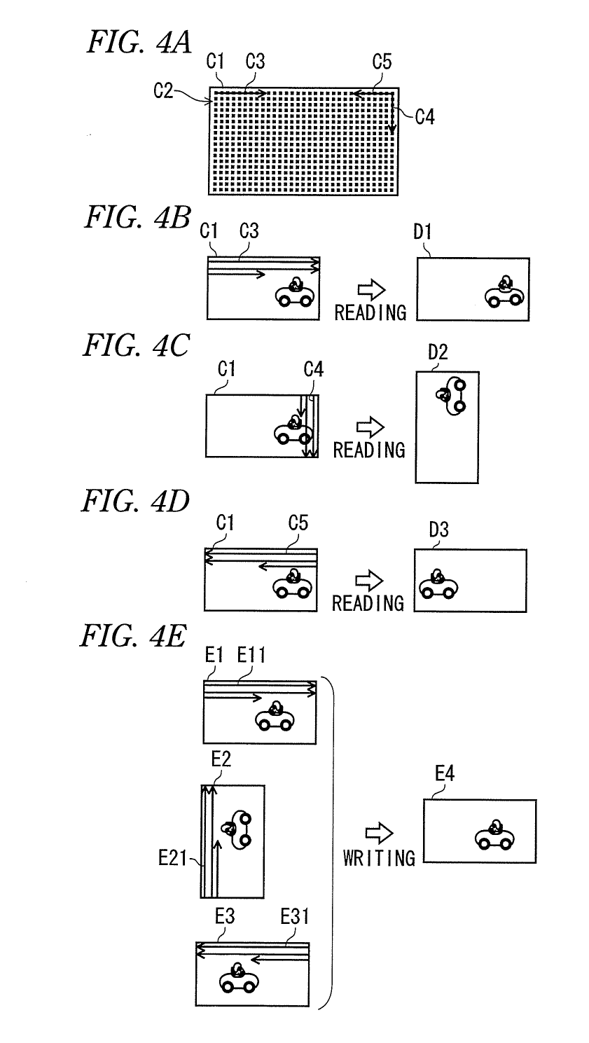

The reading/writing module 141 reads frames from the frame memory 130 and writes an interpolation frame to the frame memory 130. The reading/writing module 141 reads a frame that is oriented in a direction that accords with the directions of motion vectors detected by the motion vector detector 142 according to an instruction from the host 150. That is, if, for example, instructed by the host 150 to read a frame with its orientation changed, the reading/writing module 141 reads the frame with its orientation changed according to the instruction. How a frame is read with its orientation changed will be described later with reference to FIGS. 4A-4E.

On the other hand, if instructed by the host 150 to read a frame with its orientation unchanged, the reading/writing module 141 reads the frame with its orientation unchanged. The reading/writing module 141 outputs read-in frames to the motion vector detector 142 and the interpolation frame generator 145. The reading/writing module 141 reads two or more frames at a time for generation an interpolation frame.

The reading/writing module 141 writes an interpolation frame to the frame memory 130 according to an instruction from the host 150. More specifically, if having read frames with their orientation changed, the reading/writing module 141 writes, to the frame memory 130, an interpolation frame that has been generated based on the read-in frames so that the interpolation frame is oriented in the same direction as frames that are input from the decoder 120 to the frame memory 130 are. The orientation of an interpolation frame when it is written to the frame memory 130 will be described later with reference to FIGS. 4A-4E.

The motion vector detector 142 detects motion vectors between one of the two or more frames read by the reading/writing module 141 and another frame. More specifically, the motion vector detector 142 detects motion vectors between image blocks (between read-in frames) by performing block matching (described above) on read-in frames. The motion vector detector 142 outputs the detected motion vectors to the motion vector analyzer 143 and the interpolation frame generator 145.

The motion vector analyzer 143 analyzes the motion vectors that are input from the motion vector detector 142. For example, the motion vector analyzer 143 determines an average of the motion vectors, a maximum value of movement lengths of the motion vectors in the horizontal or vertical direction, a motion vector movement length around the frame center, or the like. The motion vector analyzer 143 stores a vector analysis result 144a in the vector information storage unit 144.

The interpolation frame generator 145 generates one or more interpolation frames based on the frames that are input from the reading/writing module 141 and the motion vectors that are input from the motion vector detector 142, and outputs the generated interpolation frame(s) to the reading/writing module 141.

The host 150 gives the reading/writing module 141 an instruction to read and an instruction to write an interpolation frame to the frame memory 130. The host 150 instructs the reading/writing module 141 to read frames from the frame memory 130 or write an interpolation frame to the frame memory 130 according to the vector analysis result 144a stored in the vector information storage unit 144. For example, if the vector analysis result 144a corresponding to the frames read by the reading/writing module 141 indicates that movement lengths in the vertical direction are large, the host 150 instructs the reading/writing module 141 to read the next frames with their orientation changed. That is, the host 150 instructs the reading/writing module 141 to read frames so that they are oriented in a direction that accords with directions and movement lengths of motion vectors detected by the motion vector detector 142.

If an interpolation frame that has been generated based on frames that were read with their orientation changed is input to the reading/writing module 141 from the interpolation frame generator 145, the host 150 instructs the reading/writing module 141 to write the received interpolation frame so that it is oriented in the ordinary direction, that is, in the same direction as frames are stored in the frame memory 130.

The video output module 160 converts frames that are input from the frame memory 130 into a signal for display and outputs the generated signal to the display unit 170. The display unit 170 displays video based on the received signal.

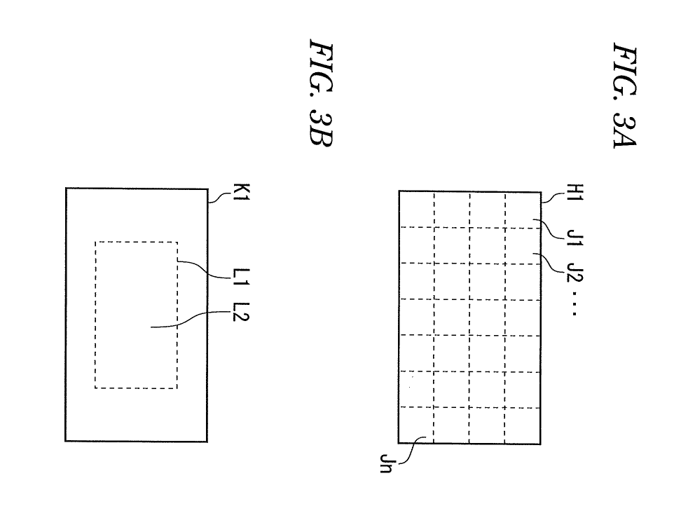

Next, example manners of analysis performed by the motion vector analyzer 143 will be described with reference to FIGS. 3A and 3B.

In the example of FIG. 3A, the motion vector analyzer 143 analyzes motion vectors of regions J1-Jn detected by the motion vector detector 142. The motion vector analyzer 143 judges whether or not the movement length, in the frame vertical direction (i.e., in the shorter-axis direction of a rectangular frame), of one of the motion vectors of the regions J1-Jn is larger than or equal to a predetermined value.

Alternatively, for example, the motion vector analyzer 143 calculates an average of the motion vectors of the regions J1-Jn and judges whether or not the vertical length of the average of the motion vectors is larger than or equal to a predetermined value or whether or not the vertical length of the average of the motion vectors is larger than or equal to its horizontal length multiplied by a predetermined magnification factor.

In the example of FIG. 3B, the motion vector analyzer 143 analyzes motion vectors corresponding to an area L1 among motion vectors detected by the motion vector detector 142. For example, the area L1 is an area that is within a predetermined distance of a center pixel L2 of each frame. The motion vector analyzer 143 judges whether or not the vertical movement length of one of the motion vectors in the area L1 is larger than or equal to a threshold value or whether or not the vertical movement length of an average of the motion vectors in the area L1 is larger than or equal to a predetermined value, or makes a similar judgment.

The above-described manners of analysis are just examples, and it suffices that the TV receiver 100 at least judge whether a vertical movement is large or not based on vertical movement lengths of detected motion vectors.

Next, example processings that the reading/writing module 141 reads a frame from or writes an interpolation frame to the frame memory 130 will be described with reference to FIGS. 4A-4E.

FIG. 4A illustrates example processing that the reading/writing module 141 reads a frame. A frame C1 includes plural pixels C2. The reading/writing module 141 can read the pixels C2 of the frame C1 in different directions by scanning the pixels C2 in directions C3-C5, for example.

FIG. 4B shows a frame D1 which is read when the frame C1 is scanned in the direction C3. If the frame C1 is scanned in such a manner that first the top row is scanned rightward starting from the top-leftmost pixel and then the following rows are scanned rightward in order, the frame D1 which is read into the reading/writing module 141 is oriented in the same direction as the original frame C1.

FIG. 4C shows a frame D2 which is read when the frame C1 is scanned in the direction C4. If the frame C1 is scanned in such a manner that first the rightmost column is scanned downward starting from the top-rightmost pixel and then the following columns are scanned downward in order, the frame D2 which is read into the reading/writing module 141 is a frame that is obtained by rotating the original frame C1 by 90-degrees counterclockwise.

FIG. 4D shows a frame D3 which is read when the frame C1 is scanned in the direction C5. If the frame C1 is scanned in such a manner that first the top row is scanned leftward starting from the top-rightmost pixel and then the following rows are scanned leftward in order, the frame D3 which is read into the reading/writing module 141 is a frame that is obtained by right-left inverting the original frame C1.

FIG. 4E illustrates how interpolation frames E1-E3 are written to the frame memory 130. The interpolation frame E1 is an interpolation frame generated from frames that are read in the same manner as the frame D1 (see FIG. 4B). The interpolation frame E2 is an interpolation frame generated from frames that are read in the same manner as the frame D2 (see FIG. 4C). The interpolation frame E3 is an interpolation frame generated from frames that are read in the same manner as the frame D3 (see FIG. 4D).

The interpolation frame E1 can be stored in the frame memory 130 so as to be oriented in the same direction as an interpolation frame E4 by writing the interpolation frame E1 to the frame memory 130 in a direction E11. That is, the interpolation frame E1 can be oriented in the same direction as frames that are input from the decoder 120 to the frame memory 130 are. Each of the interpolation frames E2 and E3 can be stored in the frame memory 130 so as to be oriented in the same direction as frames that are input from the decoder 120 to the frame memory 130 and buffered there are by writing each of the interpolation frames E2 and E3 to the frame memory 130 in a direction E21 or E31.

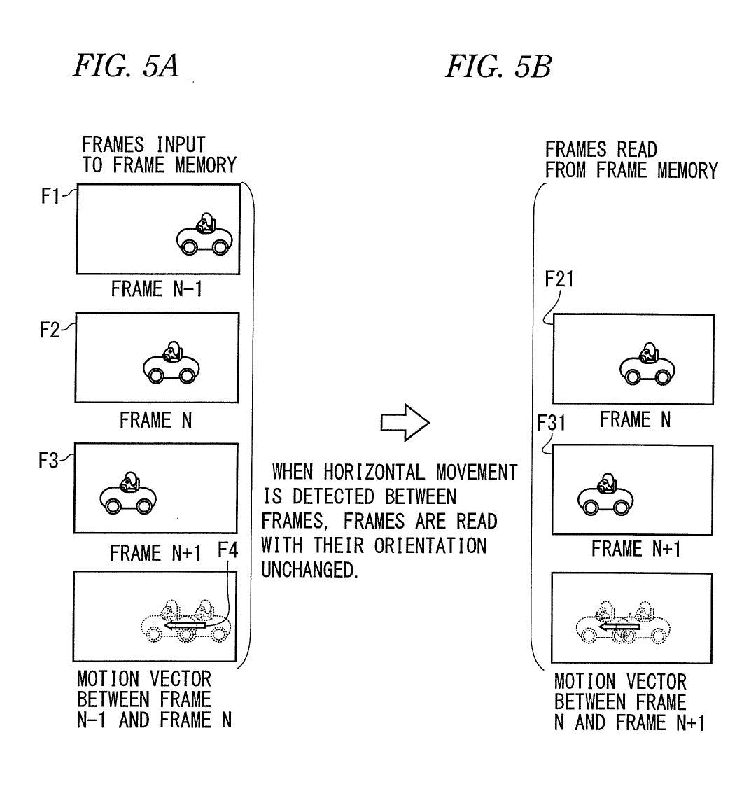

Next, example processing that the reading/writing module 141 reads frames in a case that a vertical movement between the frames is small will be described with reference to FIG. 5.

For example, where an (N−1)th frame F1, an Nth frame F2, and an (N+1)th frame F3 are input from the decoder 120 to the frame memory 130, first the reading/writing module 141 reads the frames F1 and F2 and the motion vector detector 142 detects a motion vector F4 between the frames F1 and F2. The motion vector F4 has a large horizontal movement length. And the TV receiver 100 has the wide motion vector detection range in the horizontal direction. Therefore, the reading/writing module 141 reads the frames F2 and F3 next without changing their orientation.

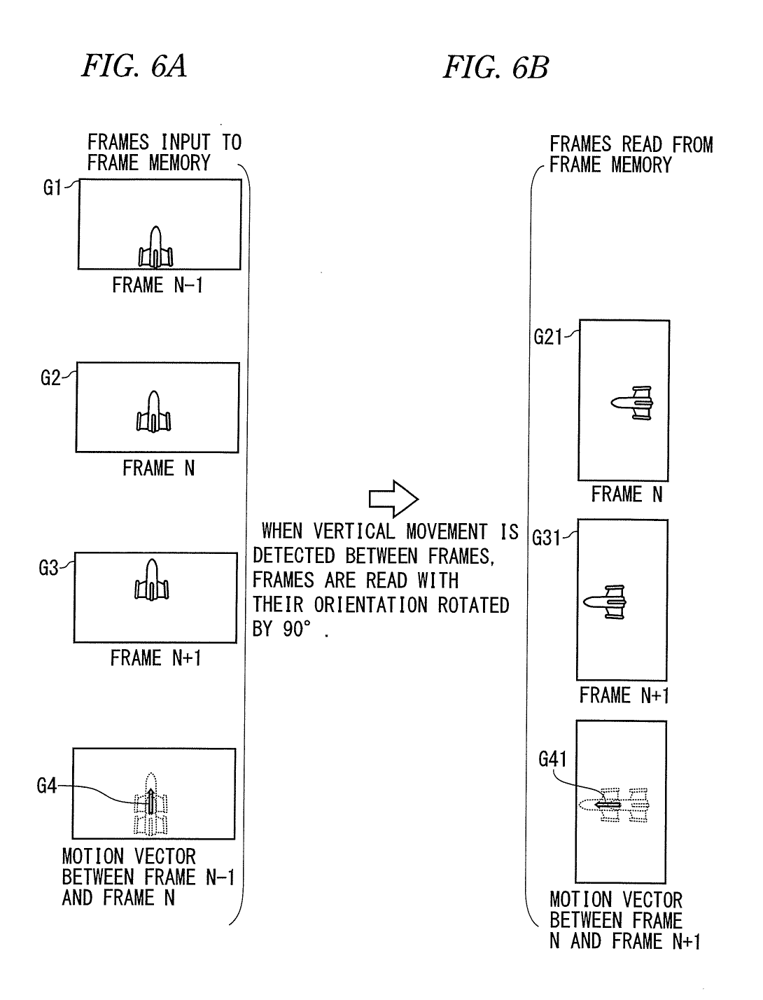

Next, example processing that the reading/writing module 141 reads frames in a case that a vertical movement between the frames is small will be described with reference to FIG. 6.

For example, where an (N−1)th frame G1, an Nth frame G2, and an (N+1)th frame G3 are input from the decoder 120 to the frame memory 130, first the motion vector detector 142 detects a motion vector G4 between the frames G1 and G2. The motion vector G4 has a large vertical movement length and a small horizontal movement length. And in the TV receiver 100 the vertical motion vector detection range is narrower than the horizontal one.

Therefore, the reading/writing module 141 reads the frames G2 and G3 next with their orientation rotated by 90 degrees. As such, the reading/writing module 141 reads frames with their orientation rotated by 90 degrees or unrotated depending on the movement length, in the frame vertical direction (i.e., in the shorter-axis direction of a rectangular frame), of a motion vector detected by the motion vector detector 142

A motion vector G41 between frames G21 and G31 that are read into the reading/writing module 141 with their orientation rotated by 90 degrees has a large horizontal movement length and a small vertical movement length. Having the wide motion vector detection range in the horizontal direction, the TV receiver 100 can detect the motion vector G41 properly.

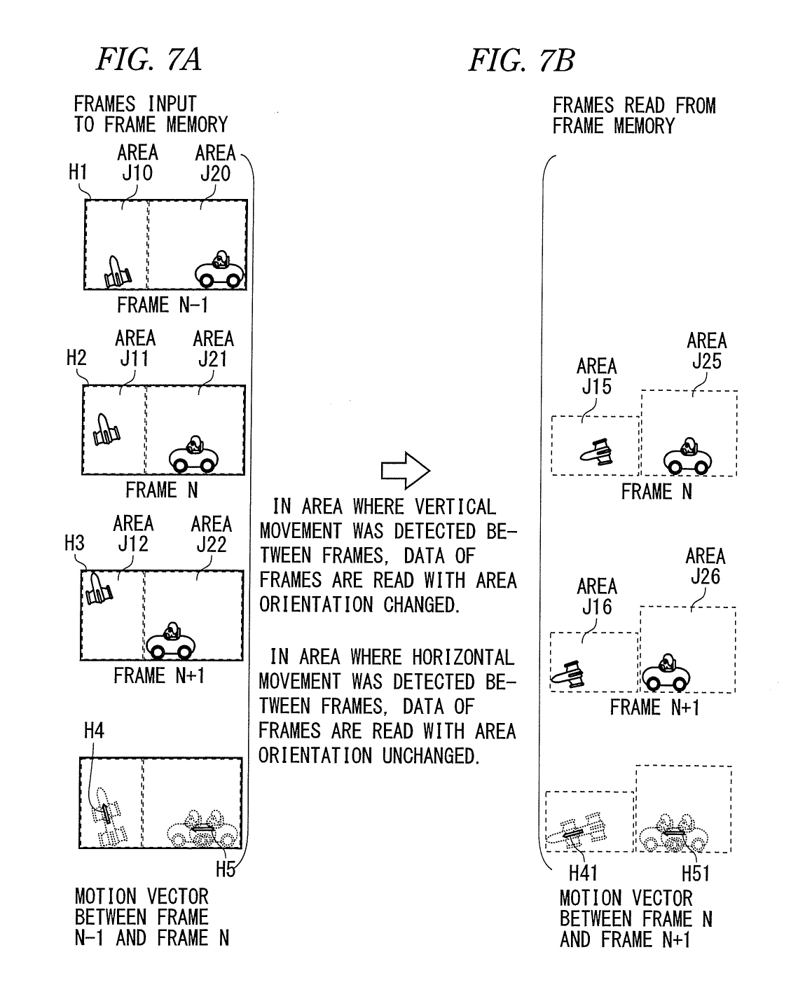

Next, example processing that the reading/writing module 141 reads frames in a case that each frame has movements in different directions will be described with reference to FIG. 7.

For example, where an (N−1)th frame H1, an Nth frame H2, and an (N+1)th frame H3 are input from the decoder 120 to the frame memory 130, first the motion vector detector 142 detects motion vectors H4 and H5 between the frames H1 and H2. Whereas the motion vector H4 has a large vertical movement length, the motion vector H5 has a small vertical movement length. The motion vector H4 is detected between partial frame areas J10 and J11, and the motion vector H5 is detected between partial frame areas J20 and J21.

Then, the reading/writing module 141 reads the frames H2 and H3 with the orientation of the areas J11 and J12 changed by 90 degrees and with the orientation of the areas J21 and J22 unchanged. That is, the motion vector detector 142 detects inter-frame motion vectors for plural respective areas and the reading/writing module 141 reads data in each area of each frame with orientation that accords with the direction and the movement length of the corresponding inter-frame motion vector.

A motion vector H41 between areas J15 and J16 that are read into the reading/writing module 141 with their orientation rotated by 90 degrees has a large horizontal movement length and a small vertical movement length. And a motion vector H51 between areas J25 and J26 that are read into the reading/writing module 141 with their orientation unchanged also has a large horizontal movement length and a small vertical movement length. Having a wider motion vector detection range in the horizontal direction than in the vertical direction, the TV receiver 100 can detect the motion vectors H41 and H51 properly.

Although in the above descriptions that have been made with reference to FIGS. 5-7 the reading/writing module 141 reads two consecutive frames and the motion vector detector 142 detects a motion vector(s) between these two frames, it is possible that the reading/writing module 141 reads more than two consecutive frames and the motion vector detector 142 detects a motion vector(s) between two of these frames. Also in this case, the reading/writing module 141 can read next frames with orientation that accords with the detected motion vector(s).

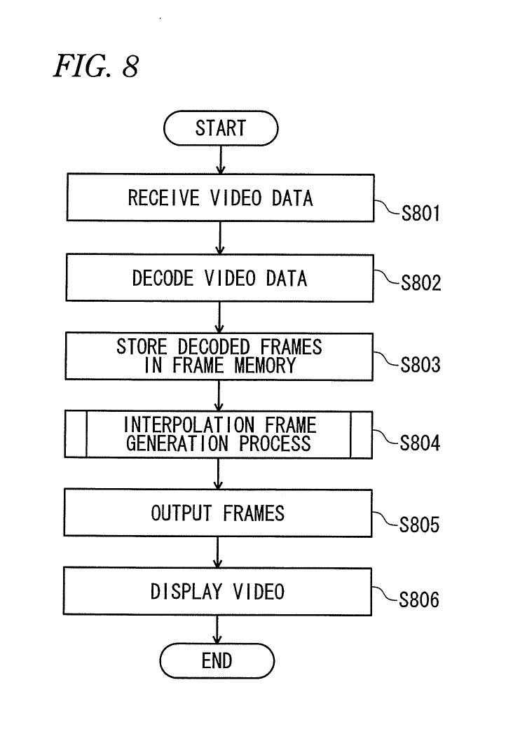

Next, an example video display process which is executed by the TV receiver 100 will be described with reference to FIG. 8.

First, at step S801, video data received by the receiving module 110 is input to the decoder 120. At step S802, the decoder 120 decodes the received video data and decoded frames to the frame memory 130. At step S803, the decoded frames are stored in the frame memory 130.

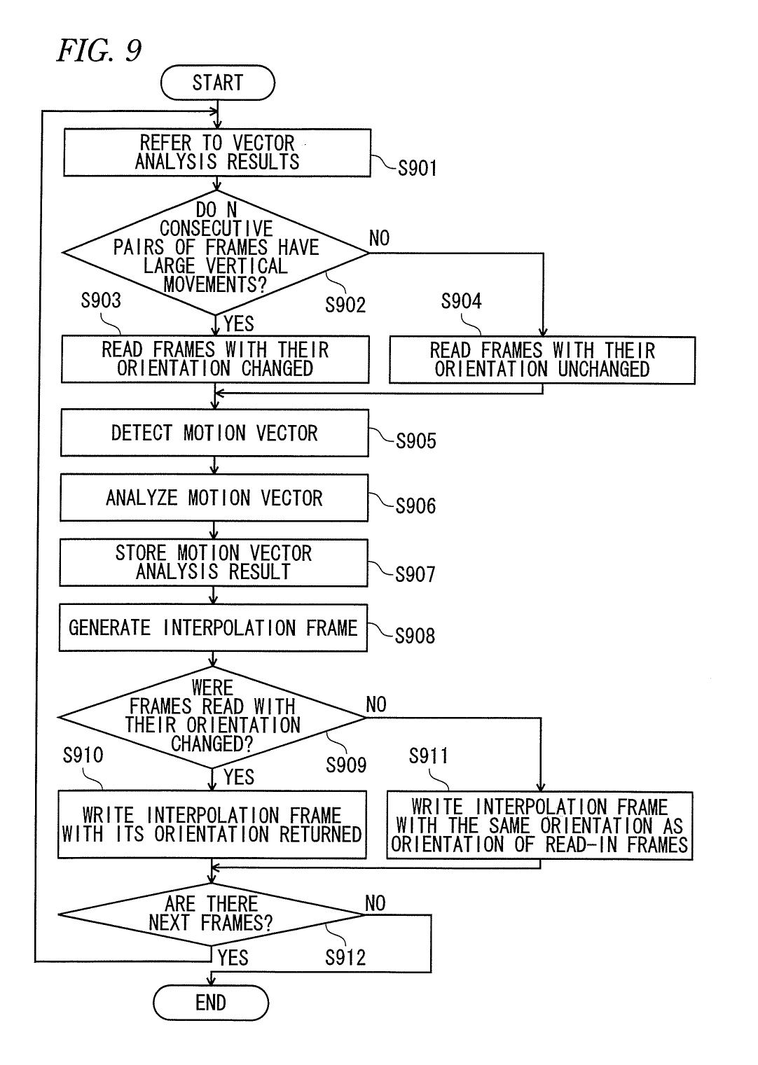

At step S804, the TV receiver 100 executes an interpolation frame generation process, that is, generates an interpolation frame based on frames stored in the frame memory 130. The generated interpolation frame is written to the frame memory 130. The interpolation frame generation process will be described later with reference to FIG. 9. At step S805, upon the writing of the interpolation frame, in the frame memory 130 the interpolation frame is inserted between the frames received from the decoder 120. The resulting frames are output to the video output module 160. At step S806, the video output module 160 generates a signal for display based on the received frames and outputs the generated signal to the display unit 170. The display unit 170 displays video based on the received signal.

Next, an example interpolation frame generation process which is executed by the TV receiver 100 will be described with reference to FIG. 9.

First, at step S901, the host 150 refers to vector analysis results 144a that are stored in the vector information storage unit 144. The vector analysis results 144a are results of analyses that have been made by the motion vector analyzer 143 on motion vectors between frames that were read by the reading/writing module 141 in the past. If the host 150 judges at step S902 that N consecutive pairs of motion-vector-analyzed frames have large vertical movements, at step S903 reading/writing module 141 reads a next pair of frames from the frame memory 130 with their orientation rotated by 90 degrees.

On the other hand, if analyzed motion vectors of N consecutive pairs of frames no not have large vertical movements (S902: no), at step S904 the reading/writing module 141 reads a next pair of frames from the frame memory 130 with the same orientation as the orientation of the frames stored in the frame memory 130.

In the description made with reference to FIG. 9, the terms “vertical direction” and “horizontal direction” mean the shorter-axis direction and the longitudinal direction of a rectangular frame, respectively. That is, when a frame is read with its orientation rotated by 90 degrees, the vertical direction according to this definition of a resulting frame becomes different from that of a read-in frame that is read without rotating an original frame. However, this definition is employed in the description made with reference to FIG. 9.

As for step S902, the TV receiver 100 judges whether or not a vertical motion is large based on, for example, the vertical component of one of detected motion vectors or an average of vertical components of detected motion vectors (described above with reference to FIGS. 3A and 3B). Any judgment method may be employed as long as it is at least based on vertical components of detected motion vectors. And the reading/writing module 141 need not always read two frames each time and may read more than two frames each time.

At step S905, the motion vector detector 142 detects a motion vector between the frames read by the reading/writing module 141. At step 906, the motion vector analyzer 143 analyses the motion vector detected by the motion vector detector 142. At step S907, the motion vector analyzer 143 stores a motion vector analysis result relating to the motion vector movement length or the like in the vector information storage unit 144.

At step S908, the interpolation frame generator 145 generates an interpolation frame to be inserted between the plural frames read by the reading/writing module 141 based on the plural frames and the motion vector between the plural frames that has been detected by the motion vector detector 142. At step S909, the host 150 judges the orientation with which the frames based on which the interpolation frame has been generated were read. If judging that the frames were read with its orientation changed (S909: yes), at step S910 the host 150 instructs the reading/writing module 141 to write the generated interpolation frame so that its orientation is returned to the orientation of the frames stored in the frame memory 130.

If instructed to write the interpolation frame so that its orientation is returned, the reading/writing module 141 writes the interpolation frame in the frame memory 130 with the instructed orientation. On the other hand, if judging that the frames were read with its orientation unchanged (S909: no), at step S911 the host 150 instructs the reading/writing module 141 to write the interpolation frame with the same orientation as the orientation of the read-in frames. The reading/writing module 141 writes the interpolation frame in the frame memory 130 with the instructed orientation.

At step S912, the host 150 judges whether or not next frames for which an interpolation frame is to be generated are stored in the frame memory 130. If next frames are stored in the frame memory 130 (S912: yes), the process returns to step S901. If not (S912: no), the interpolation frame generation process is finished.

Although in the process of FIG. 9 the reading/writing module 141 reads frames with their orientation changed by 90 degrees if N consecutive pairs of frames have large vertical movements, the invention is not limited to such a case. For example, the reading/writing module 141 may read frames with their orientation changed if a predetermined number or more of pairs of frames among N consecutive pairs of frames for which motion vectors were detected in the past have large vertical movements.

In the process of FIG. 9, if it is judged even once that frames do not have a large vertical movement in a state that pairs of frames are being read with their orientation changed by 90 degrees, frames come to be read with the same orientation as the orientation of the frames stored in the frame memory 130. However, the invention is not limited to such a case. For example, frames may be caused to be read with the same orientation as the orientation of the frames stored in the frame memory 130 if it is judged M times consecutively that frames do not have a large vertical movement in a state that pairs of frames are being read with their orientation changed by 90 degrees.

Furthermore, for example, where the motion vector detection range for right-to-left movements is wide, frames may be read with the right and left directions interchanged according to the right/left motion vector movement length.

The invention is not limited to the above embodiment itself and may be embodied while modifying constituent elements departing from the spirit and scope of the invention. For example, plural constituent elements disclosed in the embodiment may be properly combined, and several ones of the constituent elements of the embodiment may be omitted.

What is claimed is:

1. An interpolation frame generating apparatus, comprising:
an input module configured to receive plural frames;
a reading module configured to read, among the received plural frames, two or more frames each time;
a detecting module configured to detect an inter-frame motion vector between the read-in frames; and
a generating module configured to generate an interpolation frame based on the detected motion vector and the read-in frames,
wherein the reading module reads the two or more frames to have orientation corresponding to a direction of the detected motion vector.

2. The apparatus of claim 1,
wherein the input module receives rectangular frames, and
wherein the reading module reads the two or more frames to have orientation corresponding to a movement length of the detected motion vector in a shorter-axis direction of the rectangular frame.

3. The apparatus of claim 1,
wherein the input module receives rectangular frames, and
wherein the reading module reads the two or more frames to have one of two 90-degrees-rotated orientations according to a movement length of the detected motion vector in a shorter-axis direction of the rectangular frame.

4. The apparatus of claim 1,
wherein the input module receives rectangular frames,
wherein the detecting module detects plural inter-frame motion vectors, and
wherein the reading module reads the two or more frames to have orientation corresponding to a movement length of the motion vector in a given area, among the detected motion vectors, in a shorter-axis direction of the rectangular frame, the given area being within a predetermined distance of a center of the rectangular frame.

5. The apparatus of claim 1,
wherein the detecting module detects plural inter-frame motion vectors in respective areas of the frames, and
wherein the reading module reads data in each of the plural areas to have orientation corresponding to a direction of the motion vector in the respective area.

6. The apparatus of claim 1, further comprising:
an output module configured to output the interpolation frame generated by the generating module to have orientation coincide with orientation of the received plural frames.

7. The apparatus of claim 1, further comprising:
a display unit configured to display a video based on the plural frames received by the input module and the interpolation frames generated by the generating module.

8. An interpolation frame generating method, comprising:
receiving plural frames;
reading, among the received plural frames, two or more frames each time;
detecting an inter-frame motion vector between the read-in frames; and
generating an interpolation frame based on the detected motion vector and the read-in frames,
wherein the two or more frames are read to have orientation corresponding to a direction of the detected motion vector.

9. The method of claim 8,
wherein rectangular frames are received, and
wherein the two or more frames are read to have orientation corresponding to a movement length of the detected motion vector in a shorter-axis direction of the rectangular frame.
